(19) United States
(12) Patent Application Publication
(10) Pub. No.: US 2026/0264271 A1
(43) Pub. Date: Sep. 10, 2026

(54) HANDLING APPARATUS FOR HANDLING A PREFERABLY PLATE-LIKE OR PANEL-LIKE WORKPIECE

(71) Applicant: TRUMPF Werkzeugmaschinen SE + Co. KG, Ditzingen (DE)

(72) Inventors: Tim Gottschalk, Leonberg (DE); Tino Froede, Neukirch (DE); Philipp Drechsler, Neukirch (DE); Philipp Nagel, Waldenbuch (DE); Frank Bartho, Ludwigsburg (DE); Michael Harsch, Korntal- Muenchingen (DE); Falk Renger, Sohland (DE)

(21) Appl. No.: 19/661,741

(22) Filed: Apr. 29, 2026

Related U.S. Application Data
(63) Continuation of application No. PCT/EP2024/081027, filed on Nov. 4, 2024.

(30) Foreign Application Priority Data
Nov. 3, 2023 (DE) 10 2023 130 435.6

(51) Int. Cl. B25J 17/02; B25J 9/16

(52) U.S. Cl. CPC B25J 17/0208; B25J 9/1612; B25J 9/1664

(57) ABSTRACT

A handling apparatus for handling a metal sheet workpiece, including a carrier configured to be moved with a transfer movement by a transfer drive configured to handle the workpiece and a workpiece-side holder, which is provided on the carrier and has at least one holding element, which is configured to bear against the workpiece and to fix the workpiece on the holder. The handling apparatus includes an actuator for the holder having an actuator motor by which the holder is configured to be moved relative to the carrier by an actuating movement into a carrier-remote end position and into at least one carrier-side position, which is located along a movement path of the actuating movement relative to the carrying-structure-remote end position towards the carrier.

### CROSS REFERENCE TO RELATED APPLICATIONS

This application is a continuation of International Application No. PCT/EP2024/081027 (WO 2025/093762A1), filed on Nov. 4, 2024, and claims benefit to German Patent Application No. DE 10 2023 130 435.6, filed on Nov. 3, 2023. The aforementioned applications are hereby incorporated by reference herein.

### FIELD

The invention relates to a handling apparatus for handling a workpiece, in particular a metal sheet.

### BACKGROUND

Handling apparatuses for handling workpieces are used, for example, in sheet metal processing for the automated loading and unloading of sheet metal working machines.

Prior art of the type in question is disclosed in DE 10 2008 019 110 A1. In the case of the prior art, a sheet metal transport device transfers sheet metal products from a sheet metal processing machine to a pallet or to a sheet metal transport vehicle. For this purpose, traversing elements are provided which have base parts that can be moved on rails and suction plates that can be raised and lowered on the base parts and are provided with suction cups. By means of the traversing elements, sheet metal products are received at a workpiece support of the sheet metal working machine, transferred to the pallet or to the sheet metal transport vehicle and transferred to the pallet or to the sheet metal transport vehicle. For receiving the sheet metal products, the suction plates are lowered towards the sheet metal products to be picked up in relation to the base parts of the traversing elements. After the sheet metal products have been fixed by means of the suction cups, the suction plates with the sheet metal products fixed to them are lifted relative to the base parts before the base parts move together with the suction plates and the sheet metal products fixed to them to the pallet or to the sheet metal transport vehicle. There, the suction plates are lowered relative to the base parts, the sheet metal products are deposited on the pallet or the sheet metal transport vehicle and the fixing of the sheet metal products by means of the suction cups is released.

### SUMMARY

In an embodiment, the present disclosure provides a handling apparatus for handling a metal sheet workpiece, comprising a carrier configured to be moved with a transfer movement by a transfer drive configured to handle the workpiece and a workpiece-side holder, which is provided on the carrier and has at least one holding element, which is configured to bear against the workpiece and to fix the workpiece on the holder. The handling apparatus further comprises an actuator for the holder, the actuator having an actuator motor by which the holder is configured to be moved relative to the carrier by an actuating movement into a carrier-remote end position and into at least one carrier-side position, which is located along a movement path of the actuating movement relative to the carrying-structure-remote end position towards the carrier. The handling apparatus further comprises a guide by which the holder is configured to be guided on the carrier during the actuating movement and which has a carrier-side guide element connected to the carrier for movement and a holder-side guide element connected to the holder for movement. The handling apparatus further comprises a controller configured to control a longitudinal movability of the holder relative to the carrier, the longitudinal movability being directed along the movement path of the actuating movement of the holder towards the carrier. The handling apparatus further comprises a holder-side form-fitting element connected to the holder-side guide element, a carrier-side form-fitting element connected to the carrier-side guide element, and a controllable force generator. The holder-side form-fitting element and the carrier-side form-fitting element establish a form fit with a controllable degree of freedom when the holder is in the carrier-remote end position, on account of which the holder-side guide element has a controllable degree of freedom in a direction of the carrier relative to the carrier-side guide element. The degree of freedom of the holder-side guide element relative to the carrier-side guide element is controllable in that, in the carrier-remote end position of the holder, the force generator is configured to generate a contact-pressure force by which the holder-side form-fitting element acts on the carrier-side form-fitting element, a magnitude of the contact-pressure force being variably adjustable such that the holder-side guide element is or is not deflectable in the direction of the carrier relative to the carrier-side guide element and, consequently, longitudinal movability of the holder is optionally enabled or blocked.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 illustrates a handling apparatus for loading and unloading a sheet metal working machine, with a carrying structure and with a holding unit;

FIG. 2 illustrates detail II of FIG. 1 in an enlarged view;

FIG. 3 illustrates the arrangement shown in FIG. 2 with the holding unit in a carrying-structure-remote end position;

FIG. 4 illustrates the arrangement shown in FIG. 2 with the holding unit in a carrying-structure-side end position;

FIG. 5a illustrates the mutual arrangement of a carrying-structure-side guide element and a holding-unit-side guide element in the conditions shown in FIG. 3; and

FIG. 5b illustrates the mutual arrangement of the carrying-structure-side guide element and the holding-unit-side guide element from FIG. 5a in the conditions shown in FIG. 4.

### DETAILED DESCRIPTION

In an embodiment, the present disclosure provides precautions integrated into the remaining functionality of a handling apparatus in the event that, during transfer movements, the holding unit of the handling apparatus and/or a workpiece fixed to the holding unit collides with an obstacle.

In an embodiment of the present disclosure, if the holding unit and/or a workpiece fixed to the holding unit collides with an obstacle, the holding unit can perform an evasive movement directed towards the carrying structure. This evasive movement is implemented by means of a carrying-structure-side guide element and a holding-unit-side guide element and thus using components of the handling apparatus according to the present disclosure, which incidentally serve to guide the holding unit when receiving and storing workpieces.

The control device according to the present disclosure for controlling a longitudinal movability of the holding unit directed towards the carrying structure can optionally block the holding unit in the carrying-structure-remote end position against an evasive movement directed towards the carrying structure or release it for an evasive movement directed towards the carrying structure. For this purpose, the control device according to the present disclosure comprises a holding-unit-side form-fitting element, which is connected to the holding-unit-side guide element, preferably designed in one piece, and a carrying-structure-side form-fitting element, which is connected to the carrying-structure-side guide element, preferably designed in one piece. If the holding unit is in the carrying-structure-remote end position, the holding-unit-side form-fitting element and the carrying-structure-side form-fitting element establish a form fit that basically allows the holding unit to perform an evasive movement towards the carrying structure. Whether the holding unit can actually perform such an evasive movement or whether the holding unit is blocked against such an evasive movement depends on the magnitude of a contact-pressure force which the holding-unit-side form-fitting element applies to the carrying-structure-side form-fitting element and which is generated by a controllable force generator of the control device according to the present disclosure.

The holding unit located in the carrying-structure-remote end position is preferably blocked against an evasive movement directed towards the carrying structure if, during transfer movements, the carrying structure moves together with the holding unit in an area in which a collision of the holding unit and/or a workpiece fixed to the holding unit with obstacles is not to be feared.

The control device according to the present disclosure permits an evasive movement of the holding unit arranged in the carrying-structure-remote end position, directed towards the carrying structure, in particular at the beginning or towards the end of a transfer movement of the carrying structure, if the holding unit is moved to the carrying-structure-remote end position and collisions of the holding unit and/or a workpiece fixed to the holding unit with obstacles in the vicinity of the pick-up location or the deposit location of the workpiece are possible.

Irrespective of the described controllable collision protection when the holding unit is in a carrying-structure-remote end position, the handling apparatus according to the present disclosure also provides the possibility of adjusting the holding unit to a carrying-structure-side position. The holding unit is moved into a carrying-structure-side position, for example, in order to remove a workpiece produced during the sheet metal cutting process from a scrap skeleton of the sheet metal processing after it has been fixed to the holding unit.

Different designs can be provided for the holding elements of the holding unit intended for fixing workpieces. Examples include controllable suction cups or controllable holding magnets.

According to an embodiment of the present disclosure, the position of the holding unit along the movement path of its actuating movement influences the functional state of the transfer drive of the carrying structure of the handling apparatus according to the present disclosure. If a detector of a preferably numerical transfer drive control ascertains an irregular deflection of the holding unit towards the carrying structure, a transfer drive motor of the transfer drive is switched to a collision mode. In particular, the transfer drive motor can be switched off to switch to a collision mode. Alternatively, the transfer drive motor can be controlled, for example, in such a way that the speed of the transfer movement performed by the carrying structure is reduced.

In an embodiment of the present disclosure, the force generator provided for generating the variable contact pressure between the holding-unit-side form-fitting element and the carrying-structure-side form-fitting element is, for the sake of simplicity, the actuator motor, by means of which the holding unit is adjusted relative to the carrying structure into the carrying-structure-remote position and into at least one carrying-structure-side position. Alternatively, a separate force generator can be used, for example at least one magnet with an attraction force that is adjustable in magnitude, for generating the variable contact pressure between the holding-unit-side form-fitting element and the carrying-structure-side form-fitting element.

In an embodiment of the present disclosure, a piston-cylinder unit is provided as the actuator motor of the actuator for the holding unit.

Due to the high degree of reliability and due to the good integrability into the other functionality of the handling apparatus according to the present disclosure, a pneumatic piston-cylinder unit is preferred in the case of the present disclosure for adjusting the holding unit relative to the carrying structure and for generating the variable contact pressure between the holding-unit-side form-fitting element and the carrying-structure-side form-fitting element of the control device for controlling the longitudinal movability of the holding unit. Alternatively a hydraulic or an electric piston-cylinder unit can be provided as the actuator motor of the actuator for the holding unit.

In an embodiment of the handling apparatus according to the present disclosure, when the holding-unit-side guide element is deflected relative to the carrying-structure-side guide element in the direction of the carrying structure, the holding unit has transverse mobility relative to the carrying structure in the transverse direction of the movement path of the actuating movement of the holding unit, in that the holding-unit-side guide element exhibits play relative to the carrying-structure-side guide element in the transverse direction of the movement path of the actuating movement of the holding unit. In the case of this embodiment of the present disclosure, the holding unit can perform a biaxial evasive movement relative to the carrying structure.

In order to ensure the transverse mobility of the holding unit intended for the collision protection of the handling apparatus according to the present disclosure, the piston-cylinder unit is pivotably connected on the one hand to the carrying structure and on the other hand to the holding unit in the transverse direction of the movement path of the actuating movement of the holding unit.

In an embodiment of the handling apparatus according to the present disclosure, the holding-unit-side guide element relative to the carrying-structure-side guide element and thus also the holding unit relative to the carrying structure are guided without play on the carrying structure in the transverse direction of a plane which is spanned by an axis of longitudinal movability and by an axis of transverse movability of the holding unit. The direction of the absence of play is fixed depending on the application, in particular taking into account the direction of the transfer movement performed by the carrying structure.

According to an embodiment, a sliding guide is provided to guide the holding-unit-side guide element perpendicular to said plane without play.

In an embodiment of the present disclosure, the sliding guide has a sliding element for this purpose, in particular a sliding block, which is arranged between the holding-unit-side guide element and a carrying-structure-side abutment connected to the carrying structure.

In order to adjust the sliding guide of the holding-unit-side guide element and/or to compensate for signs of wear, the sliding element of the sliding guide for the holding-unit-side guide element can, in an embodiment of the present disclosure, be adjusted relative to the carrying-structure-side abutment in the direction of the holding-unit-side guide element.

In an embodiment of the present disclosure, the holding unit is connected to the carrying structure of the handling apparatus at multiple points in the manner described above. For this purpose, multiple actuators, multiple guide devices and multiple control devices for controlling the longitudinal movability of the holding unit are provided for the holding unit.

Embodiments of the present disclosure will be explained in more detail below on the basis of exemplary schematic illustrations.

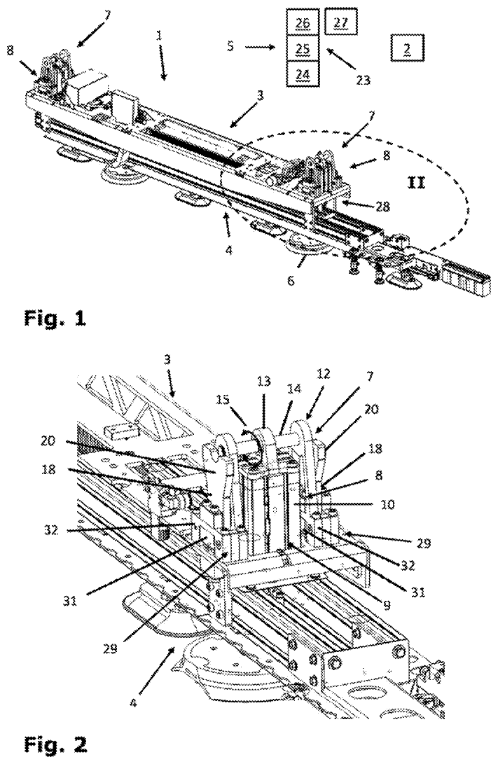

According to FIG. 1, a handling apparatus 1 provided for loading and unloading a sheet metal working machine 2 has a carrying structure 3 and a workpiece-side holding unit 4. For handling a sheet metal to be processed and/or finished sheet metal parts produced on the sheet metal working machine 2, the carrying structure 3 can be moved with a transfer movement together with the holding unit 4 by means of a conventional numerically controlled transfer drive 5 of the handling apparatus 1. The holding unit 4 is provided with holding elements in the form of various types of suction cups 6 of the usual design.

For receiving a raw sheet to be processed on the sheet metal working machine 2, the handling apparatus 1 moves over a stack of raw sheets. During the traversing movement, the holding unit 4 is in a carrying-structure-remote end position relative to the carrying structure 3 (FIGS. 1, 3, 5a). With the holding unit 4 in the carrying-structure-remote end position, the carrying structure 3 is lowered and the suction cups 6 are placed against the upper face of the raw sheet arranged at the top of the stack of raw sheets. By actuating the suction cups 6, the raw sheet interacted with by the suction cups 6 is fixed to the holding unit 4 in the usual manner. With the holding unit 4 in the carrying-structure-remote end position and the raw sheet fixed to it, the handling apparatus 1 then moves to a position above a workpiece support of the sheet metal working machine 2. By lowering the carrying structure 3 with the holding unit 4 arranged in the carrying-structure-remote end position, the raw sheet is deposited on the workpiece support of the sheet metal working machine 2.

After releasing the suction cups 6 from the raw sheet metal deposited on the workpiece support, the handling apparatus 1 with the holding unit 4 arranged in the carrying-structure-remote end position moves to a waiting position in the vicinity of the sheet metal working machine 2. The handling apparatus 1 remains there until a finished sheet metal part has been created by a separating machining process of the raw sheet metal on the sheet metal working machine 2. The handling apparatus 1 then moves back to the workpiece support of the sheet metal working machine 2 in order to receive the finished sheet metal part created by processing the raw sheet.

For this purpose, the carrying structure 3 with the holding unit 4 arranged in the carrying-structure-remote end position is lowered towards the finished sheet metal part until the relevant suction cups 6 touch down on the upper face of the finished sheet metal part. After activation of the suction cups 6 in contact with the finished sheet metal part, the holding unit 4 is lifted together with the fixed finished sheet metal part relative to the carrying structure 3 from the carrying-structure-remote end position to a carrying-structure-side end position (FIGS. 2, 4, 5b).

Two actuators 7 and two guide devices 8, which are spaced apart from one another in the longitudinal direction of the carrying structure 3, are used to carry out the described movements of the holding unit 4 relative to the carrying structure 3. The actuator 7 on the right in FIG. 1 and the guide device 8 on the right in FIG. 1 are shown in detail in FIGS. 2 to 4.

The actuator 7 has a pneumatic piston-cylinder unit 9 as the actuator motor. A piston 10 of the piston-cylinder unit 9 is pivotably mounted on a bearing and guide frame 12 of the carrying structure 3. Here, a bearing eye 13 provided on the piston 10 is penetrated by a bearing axis 14 of the bearing and guide frame 12. The direction of the pivoting movement of the piston 10 relative to the carrying structure 3 is illustrated in FIG. 2 by way of a double arrow 15.

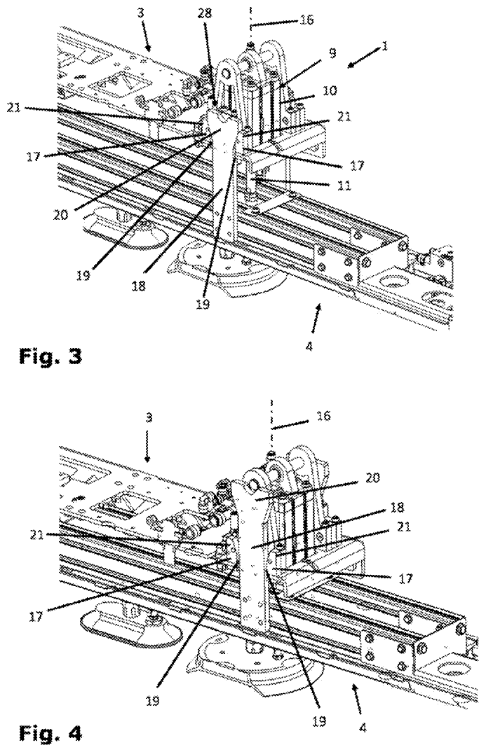

The free end of the piston rod 11 of the piston-cylinder unit 9 is pivotably fixed to the holding unit 4 (FIG. 3).

A movement path along which the holding unit 4 is raised into the carrying-structure-side end position and lowered into the carrying-structure-remote end position by means of the piston-cylinder unit 9 is indicated in FIGS. 3 to 5b as a dotted axis of movement 16.

During its actuating movements, the holding unit 4 is guided on the carrying structure 3 by means of the guide device 8. The guide device 8 comprises a carrying-structure-side guide element 17 connected to the carrying structure 3 and a holding-unit-side guide element 18 connected to the holding unit 4 on both sides of the piston-cylinder unit 9.

Between the holding-unit-side guide elements 18 on the one hand and the associated carrying-structure-side guide elements 17 on the other, there is a gap 19 on both sides in the transverse direction of the axis of movement 16 and thus a certain degree of play is present.

A trapezoidal holding-unit-side form-fitting element 20 is designed in one piece with each of the holding-unit-side guide elements 18. A carrying-structure-side form-fitting element 21 is designed in one piece with the carrying-structure-side guide elements 17 on both sides of the piston-cylinder unit 9. The carrying-structure-side form-fitting elements 21 have an inner contour that is complementary to the outer contour of the respective holding-unit-side form-fitting element 20.

The holding-unit-side form-fitting elements 20 and the carrying-structure-side form-fitting elements 21 are part of a control device 28 for controlling the longitudinal movability of the holding unit 4 relative to the carrying structure 3 along the axis of movement 16.

If the holding unit 4 is lowered relative to the carrying structure 3 into the carrying-structure-remote end position (FIGS. 1, 3, 5a), a form fit is established between the holding-unit-side form-fitting elements 20 and the carrying-structure-side form-fitting elements 21.

Depending on the magnitude of the force which the piston-cylinder unit 9 applies to the holding unit 4 in its carrying-structure-remote end position, the holding-unit-side form-fitting elements 20 are pressed against the carrying-structure-side form-fitting elements 21 with a greater or lesser contact-pressure force.

If the pressure inside of the piston 10 of the piston-cylinder unit 9 is adjusted to a relatively low value, there is longitudinal movability of the holding unit 4 along the axis of movement 16 and the holding unit 4 arranged in the carrying-structure-remote end position can perform an evasive movement relative to the carrying structure 3 directed along the axis of movement 16 towards the carrying structure 3. The pressure inside of the piston 10 of the piston-cylinder unit 9 is adjusted to a relatively low value for collision protection of the handling apparatus 1 when a raw sheet is deposited on the workpiece support of the working machine 2 and/or when a finished sheet metal part is picked up from the workpiece support. In these operating situations, there is a particular risk of collisions between the holding unit 4 or a workpiece fixed to the holding unit 4 and obstacles.

If the pressure inside of the piston 10 of the piston-cylinder unit 9 is adjusted to a large value, the holding-unit-side form-fitting elements 20 apply a large contact-pressure force to the carrying-structure-side form-fitting elements 21, as a result of which the holding unit 4 is blocked against an evasive movement along the axis of movement 16 towards the carrying structure 3.

This adjustment of the pressure inside of the piston 10 of the piston-cylinder unit 9 is selected in phases of the transfer movements performed by the handling apparatus 1 in which there is at most a low risk of collisions of the holding unit 4 or a workpiece fixed to the holding unit 4 with obstacles. By securely fixing the holding unit 4 in the carrying-structure-remote position, accidental deflection of the holding unit 4 in the direction of the carrying structure 4 and the associated undesired response of the collision protection of the handling apparatus 1 are effectively prevented.

If, as a result of a collision of the holding unit 4 or a workpiece fixed to the holding unit 4 with an obstacle, the holding-unit-side form-fitting elements 20 and the holding-unit-side guide elements 18 are deflected relative to the carrying-structure-side form-fitting elements 21 and the carrying-structure-side guide elements 17 towards the carrying structure 3, the holding unit 4 can also perform a evasive movement in the transverse direction of the axis of movement 16 relative to the carrying structure 3 in addition to the evasive movement along the axis of movement 16.

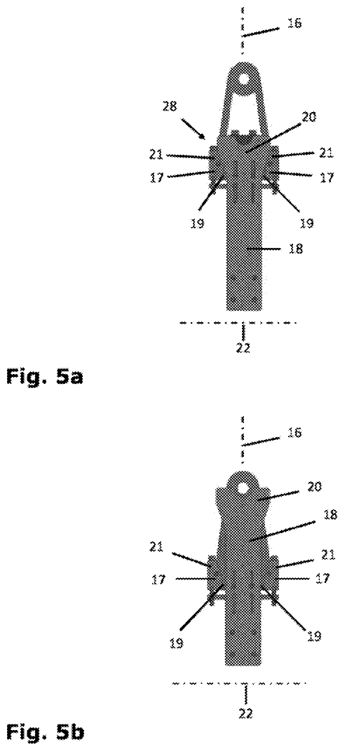

Evasive movements of the holding unit 4 in the transverse direction of the axis of movement 16 are made possible by the play existing in the transverse direction of the axis of movement 16 between the holding-unit-side guide elements 18 and the carrying-structure-side guide elements 17. An axis 22 of transverse movability of the holding unit 4 is shown as dotted lines in FIGS. 5a and 5b.

FIG. 5a shows the conditions when the holding unit 4 is in a carrying-structure-remote position. If the contact-pressure force between the holding-unit-side form-fitting elements 20 and the carrying-structure-side form-fitting elements 21 is low, the holding-unit-side guide elements 18 together with the holding unit 4 can perform an evasive movement along the axis of movement 16 towards the carrying structure 3 with respect to the carrying-structure-side guide elements 17 and the carrying structure 3 in the event of a collision. If the holding-unit-side form-fitting elements 20 are pressed against the carrying-structure-side form-fitting elements 21 with a correspondingly large contact-pressure force, the holding unit 4 is blocked against an evasive movement directed towards the carrying structure 4 in the event of a collision.

Perpendicular to the drawing plane of FIGS. 5a and 5b, which is spanned by the axis of movement 16 (axis of longitudinal movability of the holding unit 4) and the axis 22 of transverse movability of the holding unit 4, the holding-unit-side guide elements 18 and with these the holding unit 4 are mounted on the carrying structure 3 without play.

For this purpose, a sliding guide 29 is provided on both sides of the piston-cylinder unit 9 (FIG. 2). The sliding guides 29 are each formed by sliding elements arranged on both sides of the relevant holding-unit-side guide element 18. Sliding blocks 31, which are provided on both sides of each of the holding-unit-side guide elements 18, serve as sliding elements. FIG. 2 shows only the sliding blocks 31 on the side of the two holding-unit-side guide elements 18 facing the observer.

In order to adjust the sliding guides 29, in particular to compensate for wear-related play in the sliding guides 29, the sliding blocks 31 can each be adjusted relative to a carrying-structure-side abutment 32 in the direction of the relevant holding-unit-side guide element 18.

In order to protect the handling apparatus 1 against collision, irregular evasive movements of the holding unit 4, which is arranged in the carrying-structure-remote position, along the axis of movement 16 towards the carrying structure 3 cause the transfer drive 5 to be controlled accordingly. A numerical transfer drive control 23 of the transfer drive 5 provided for this purpose is shown very schematically in FIG. 1. The transfer drive control 23 comprises a detector 24, by means of which the current position of the holding unit 4 can be detected, in which the holding unit 4 is located relative to the carrying structure 3 along the axis of movement 16 of the actuating movement of the holding unit 4. In a comparison unit 25 of the transfer drive control 23, the current position of the holding unit 4 is compared with a target position stored in the transfer drive control 23, in which the holding unit 4 is located relative to the carrying structure 3 along the axis of movement 16 of the actuating movement of the holding unit 4 in a collision-free state of the handling apparatus 1. If a comparison of the current position of the holding unit 4 with the target position reveals a relevant deviation of the current position from the target position, a switching device 26 is used to switch a transfer drive motor 27 of the transfer drive 5 into a collision mode, in the exemplary case shown, to bring it to a standstill.

FIG. 5b shows the conditions when the holding unit 4 is in the carrying-structure-side end position. By means of the piston-cylinder unit 9, the holding unit 4 was raised relative to the carrying structure 3 along the axis of movement 16 into the position shown in order to separate a finished sheet metal part fixed to the holding unit 4 from the scrap skeleton remaining on the workpiece support of the working machine 2 after a separating sheet metal processing operation. In order to remove the finished sheet metal part, the carrying structure 3 is first lifted together with the holding unit 4 arranged in the carrying-structure-side end position and the finished sheet metal part fixed to it relative to the workpiece support. The holding unit 4 with the finished sheet metal part is then lowered relative to the carrying structure 3 into the carrying-structure-remote end position and secured by applying a high pressure to the piston 10 of the piston-cylinder unit 9 for the subsequent transfer movement of the handling apparatus 1 in the carrying-structure-remote end position.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A handling apparatus for handling a metal sheet workpiece, comprising:
a carrier configured to be moved with a transfer movement by a transfer drive configured to handle the workpiece;
a workpiece-side holder, which is provided on the carrier and has at least one holding element, which is configured to bear against the workpiece and to fix the workpiece on the holder;
an actuator for the holder, the actuator having an actuator motor by which the holder is configured to be moved relative to the carrier by an actuating movement into a carrier-remote end position and into at least one carrier-side position, which is located along a movement path of the actuating movement relative to the carrying-structure-remote end position towards the carrier;
a guide by which the holder is configured to be guided on the carrier during the actuating movement and which has a carrier-side guide element connected to the carrier for movement and a holder-side guide element connected to the holder for movement;
a controller configured to control a longitudinal movability of the holder relative to the carrier, the longitudinal movability being directed along the movement path of the actuating movement of the holder towards the carrier;
a holder-side form-fitting element connected to the holder-side guide element;
a carrier-side form-fitting element connected to the carrier-side guide element; and
a controllable force generator,
wherein the holder-side form-fitting element and the carrier-side form-fitting element establish a form fit with a controllable degree of freedom when the holder is in the carrier-remote end position, on account of which the holder-side guide element has a controllable degree of freedom in a direction of the carrier relative to the carrier-side guide element and
wherein the degree of freedom of the holder-side guide element relative to the carrier-side guide element is controllable in that, in the carrier-remote end position of the holder, the force generator is configured to generate a contact-pressure force by which the holder-side form-fitting element acts on the carrier-side form-fitting element, a magnitude of the contact-pressure force being variably adjustable such that the holder-side guide element is or is not deflectable in the direction of the carrier relative to the carrier-side guide element.

2. The handling apparatus according to claim 1, comprising:
a transfer drive control configured for the transfer drive of the carrier;
a detector, by which a current position of the holder is configured to be detected, in which the holder is located relative to the carrying structure along the movement path of the actuating movement of the holder;
a comparison unit, by which the current position of the holder is configured to be compared with a target position of the holder, in which the holder is located relative to the carrying structure along the movement path of the actuating movement of the holder in a collision-free state of the handling apparatus; and
a switch which is connected to the comparison unit and by which a transfer drive motor of the transfer drive is configured to be switched to a collision mode based on the current position of the holder deviating from the target position of the holder.

3. The handling apparatus according to claim 1, wherein the actuator motor of the actuator for the holder is provided as the force generator of the controller for controlling the longitudinal movability of the holder.

4. The handling apparatus according to claim 1, wherein a piston-cylinder is provided as the actuator motor of the actuator for the holder.

5. The handling apparatus according to claim 1, wherein, based on the holder-side guide element being deflected relative to the carrier-side guide element in the direction of the carrier, the holder is configured to have transverse movability relative to the carrier in a transverse direction of the movement path of the actuating movement of the holder, and wherein the holder-side guide element exhibits play relative to the carrier-side guide element in the transverse direction of the movement path of the actuating movement of the holder.

6. The handling apparatus according to claim 4, wherein the piston-cylinder is pivotably connected on one hand to the carrier and on another hand to the holder in a transverse direction of the movement path of the actuating movement of the holder.

7. The handling apparatus according to claim 5, wherein the holder-side guide element is guided without play on the carrier in a transverse direction of a plane which is spanned by an axis of longitudinal movability and by an axis of transverse movability of the holder.

8. The handling apparatus according to claim 7, wherein the holder-side guide element is configured to be guided without play on the carrier by a sliding guide.

9. The handling apparatus according to claim 8, wherein the sliding guide is formed by a sliding element arranged between the holder-side guide element and a carrier-side abutment connected to the carrier.

10. The handling apparatus according to claim 9, wherein the sliding element is configured to be adjustable relative to the carrier-side abutment in the direction of the holder-side guide element.

11. The handling apparatus according to claim 1, wherein the actuator for the holder is provided as a first actuator, the guide is provided as a first guide and the controller for controlling the longitudinal movability of the holder is provided as a first controller, and wherein at least one further actuator and/or one further guide and/or one further controller is/are provided.

12. The handling apparatus according to claim 1, wherein longitudinal movability of the holder is configured to be enabled or blocked by the holder-side guide element being deflectable or not deflectable in the direction of the carrier relative to the carrier-side guide element.
